(19) United States
(12) Patent Application Publication
(10) Pub. No.: US 2005/0127678 A1
(43) Pub. Date: Jun. 16, 2005

(54) System for generating power through the capture of gas bubbles and method therefor

(76) Inventor: Kenneth Rea, Boulder City, NV (US)

Correspondence Address: WEISS & MOY PC, 4204 NORTH BROWN AVENUE, SCOTTSDALE, AZ, 85251, US

(21) Appl. No.: 11/007,690

(22) Filed: Dec. 8, 2004

Related U.S. Application Data
(60) Provisional application No. 60/528,526, filed on Dec. 11, 2003.

(51) Int. Cl. H02P 9/04; F02M 37/00; B01D 47/00; F02M 69/02

(52) U.S. Cl. 290/1 R

(57) ABSTRACT

A system for capturing gas bubbles and converting the captured gas bubbles into electrical energy uses an elongated tubular structure filled with a liquid and having an open top end. The tubular structure is positioned over a gas source. The gas source creates gas bubbles which will flow up the tubular structure and out the top end. At least one turbine is coupled to an interior surface of the tubular structure. The turbine will capture the gas bubbles causing the turbines to rotate and produces electrical power.

### RELATED APPLICATIONS

This application is related to U.S. Provisional Application entitled “Rea Gas Generator Column,” filed on Dec. 11, 2003, having a Ser. No. 60/528,526 in the name of the same inventor as the present patent application. The present application claims the benefit of the above provisional application.

### BACKGROUND OF THE INVENTION

1. Field of the Invention

This invention relates generally to alternative energy generation devices and, more specifically, to a system and method for capturing gas bubbles and converting the captured gas bubbles into electricity.

2. Description of the Prior Art

Due to the limited supplies of fossil fuels, people have been searching for cheap and reusable sources of power. Many people have focused on the use of flowing water to provide power. Hydroelectric generating plants have been used for many years to generate large quantities of electrical energy for widespread distribution. However, hydroelectric generating plants have one main problem. Hydroelectric generating plants generally require the construction of large dams to stop the flow of water on the river. The dam construction usually requires major permanent environmental changes to the areas where the dam is built and is costly to install.

Many people have also focused on wind-power as a cheap and reusable source of power. Wind-powered devices have been used to perform mechanical work and to generate electricity. However, wind-powered devices have only been used only on a limited scale. Furthermore, wind-powered devices are expensive, inefficient, dangerous, noisy, and unpleasant to be around. In order to capture a large volume of wind, wind-powered devices have to be built very large in size and quantity. As a result, they cannot be distributed throughout population centers, but must be installed some distance away where there are large open spaces. Then, like dams with hydro-electric generators, the electrical energy the wind-powered devices generate must be transmitted, at considerable cost and with considerable lost energy, to the population centers where the energy is needed.

Therefore, a need existed to provide an improved energy conversion device that overcomes the shortcomings of existing prior art devices. Such a device could utilize the energy of flowing gas through a liquid. The bubbles generated by the flowing gas through the liquid may be captured and used to provide mechanical energy or electrical energy.

### SUMMARY OF THE INVENTION

In accordance with one embodiment of the present invention, it is an object of the present invention to provide an improved energy conversion device.

It is another object of the present invention to provide an to provide an improved energy conversion device that overcomes the shortcomings of existing prior art devices.

It is still another object of the present invention to provide an improved energy conversion device that utilizes the energy of flowing gas through a liquid.

It is still another object of the present invention to provide an improved energy conversion device that captures the bubbles generated by the flowing gas through the liquid may be and uses the bubbles to provide mechanical energy or electrical energy.

### BRIEF DESCRIPTION OF THE EMBODIMENTS

In accordance with one embodiment of the present invention, a system for capturing gas bubbles and converting the captured gas bubbles into electrical energy is disclosed. The system for capturing gas bubbles and converting the captured gas bubbles into electrical energy uses an elongated tubular structure filled with a liquid. The tubular structure is positioned over a gas source. The gas source creates gas bubbles which will flow up the tubular structure. At least one turbine is coupled to an interior surface of the tubular structure. The turbine will capture the gas bubbles causing the turbines to rotate and produces electrical power.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified functional block diagram of a system for capturing gas bubbles and converting the captured gas bubbles into electricity.

FIG. 2 is a simplified functional block diagram of one embodiment of a turbine used in the system depicted in FIG. 1.

FIG. 3 is a simplified functional block diagram of another embodiment of a turbine used in the system depicted in FIG. 1.

FIG. 4 is a simplified functional block diagram of another embodiment of a turbine used in the system depicted in FIG. 1.

FIG. 5 is a simplified functional block diagram of a system for capturing gas bubbles and converting the captured gas bubbles into electricity using a hydrogen generation device for generating the gas bubbles.

FIG. 6 is a simplified functional block diagram of a system for capturing gas bubbles and converting the captured gas bubbles into electricity using a hydro-turbine for generating the gas bubbles.

FIG. 7 is a simplified functional block diagram of a system for capturing gas bubbles and converting the captured gas bubbles into electricity using air chambers and valves for generating the gas bubbles.

FIG. 8 is a simplified functional block diagram of a system for capturing gas bubbles and converting the captured gas bubbles into electricity with interfacing piping.

FIG. 9 is a simplified functional block diagram of a system for capturing gas bubbles and converting the captured gas bubbles into electricity for use in a submerged tank or in a body of water.

### DETAILED DESCRIPTION OF THE PREFERRED EMBODIMENT

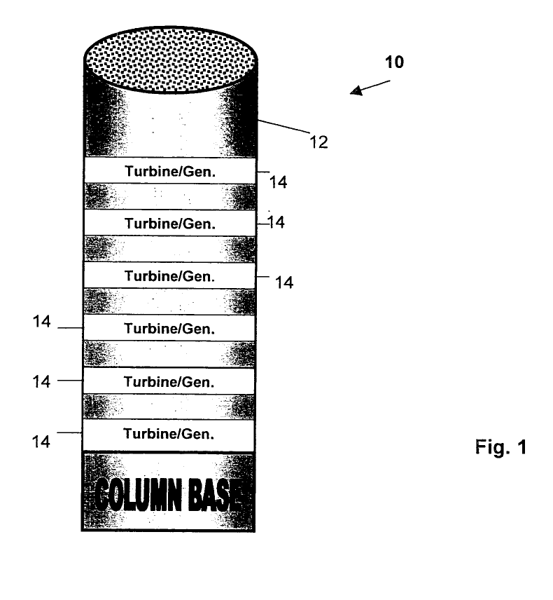

Referring to FIG. 1, a system for capturing gas bubbles and converting the captured gas bubbles into electricity 10 (hereinafter system 10) is shown. The system 10 uses a column 12. The column 12 is designed to be submerged underwater or any other type of liquid or if not submerged, filled with a liquid and have interfacing piping as will be discussed below. While the remainder of the description will reference water, it should be noted that other types of liquids may be used without departing from the spirit and scope of the present invention.

The column 12 may be made out of any type of sturdy material. The main requirement is that the material can withstand the stress of being underwater. In general, a sturdy metal column 12 made of steel or the like is preferred. However, the listing of the above should not be seen as to limit the scope of the present invention. The column 12 may come in different shapes and sizes. While a circular column 12 is shown, other sizes and shapes may be used without departing from the spirit and scope of the present invention.

The column 12 is submerged under water so that the column 12 is completely full of water and the top of the column 12 is pointing in an upward position. Alternatively, water may be poured or placed into the interior of the column 12. Air or another gas will flow upward through the water that has filled the column 12. The gas flowing through the column 12 will create a plurality of gas bubbles. The gas bubbles will flow up the length of the column 12 and out of the top of the column 12 which is open.

A plurality of bubble capturing devices 14 are position inside the column 12. The devices 14 will capture the force of the rising gas bubbles and convert this to electrical power. The devices 14 are positioned in the column 12 so that each of the devices 14 will capture the force of the rising gas bubbles and convert this to electrical power. In FIG. 1, the devices 14 are a plurality of turbines 14′ similar to that used in a hydroelectric plant. As the bubbles rise up the column 12, the bubbles will cause each of the turbines 14′ to rotate. The rotational energy is sent to a generator which will generate electrical power. Since there is a plurality of turbines 14′, the bubbles are captures over and over again until they reach the surface of the column 12. Thus, the turbines 14′ harness the buoyancy of the rising bubbles and convert this to electrical power.

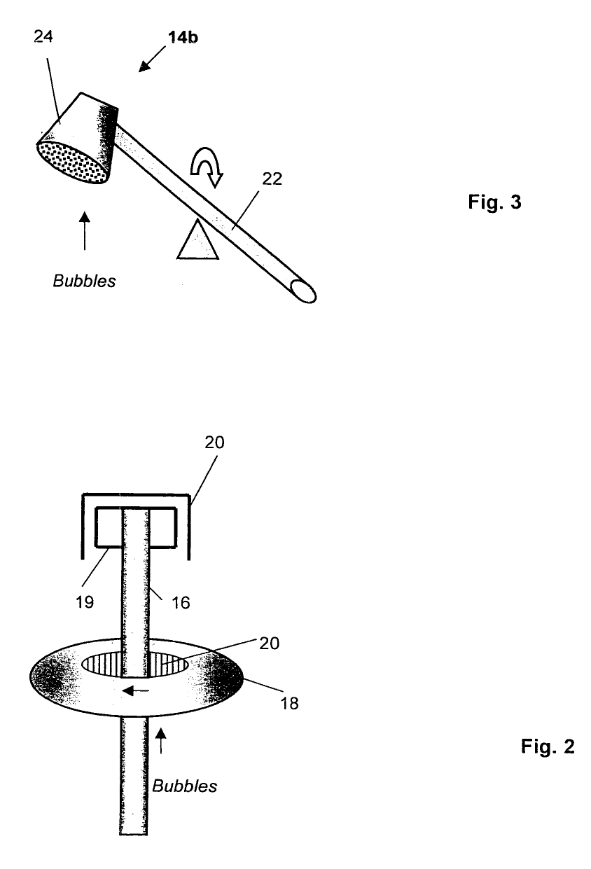

Referring to FIG. 2, one embodiment of the turbine 14a is shown. In this embodiment, the turbine 14a is comprised of a shaft 16. The shaft 16 is placed inside the container 12 and generally runs the length of the column 12. A plurality of disks 18 are coupled to the shaft 16. Alternatively, each turbine 14a may be comprised of a plurality of small shafts wherein each shaft would have a single disk coupled to the shaft.

As the bubbles rise, the bubbles will cause the disk 18 to turn and rotate. This will in turn rotate the shaft 16. The shaft 16 will have a plurality of magnets 19. The rotating shaft 16 will rotate the magnets 19 past copper coils 20 to produce electricity. Alternatively, the shaft 16 may be stationary. The shaft 16 may be magnetized to form one large magnet 19. The disk 18 could have copper coils 20 located in the interior of the disk 18. The bubbles will cause the disk 18 to rotate around the shaft 16 which is a magnet 18 thereby generating electricity.

Referring to FIG. 3, a second embodiment of the turbines 14b is shown. In this embodiment, the turbines 14b are comprised of a lever 22. A flotation cup 24 is coupled to the lever 22. Once the flotation cup 24 has been fully raised, the floatation cup 24 will fall back to a beginning position where the process will start all over. The up and down movement of the flotation cup 24 will move the lever 22. The movement of the lever 22 is used to power a generator for producing electricity.

The flotation cup 24 may fall back to a starting position in any number of ways. First, a device may be used to invert the flotation cup 24 over once it reaches a fully raised position. The device would then flip the flotation cup 24 back over once it has returned to a starting position. Alternatively, a valve may be placed in the flotation cup 24 which will open up once the flotation cup 24 reaches a fully raised position to allow the air bubbles to escape and for the flotation cup 24 to fall back to a starting position. The valve would close once the flotation cup 24 reaches the starting position. The above are just given as examples and should not be seen as to limit the scope of the present invention. Other devices may be used to help the flotation cup 24 fall back to a starting position without departing from the spit and scope of the present invention.

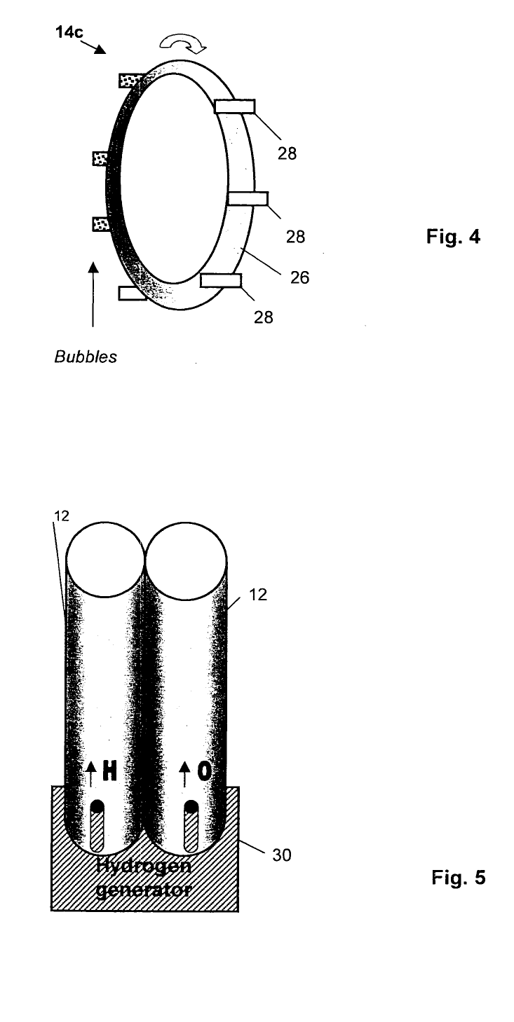

Referring to FIG. 4, a third embodiment of the turbine 14c is shown. In this embodiment, the turbine 14c is comprised of a wheel 26. The wheel 26 will have a plurality of vanes 28 coupled to the outer perimeter of the wheel 26. As the bubbles rise, the vanes 28 will capture the bubbles thereby rotating the wheel 26. The rotation of the wheel 26 is then used to power a generator for producing electricity similar to a water wheel.

The gas bubbles may be generated in a plurality of different manners. The chemical creation of gas, naturally occurring or artificial, could be used as a source of gas bubbles for the system 10. For example, the system 10 may be positioned over an underground source of gas in a body of water such as those discovered when drilling for oil in the ocean or in a lake. Natural gas or methane deposits in a body of water could be tapped and released into the columns 12. Also, chemicals could be released into the column 12, which would interact with the liquid in the column 12 to create gas bubbles in the column 12. The gasification of biomass may be used to form the gas bubbles. The height and shape of the columns, the number and type of turbines 14, and other factors would be adjusted to provide maximum efficiency. Alternatively, one may pipe the gas under pressure to the system 10. Air or another gas would be pumped in an efficient manner as to get a cost effective transfer of energy. Again, the height and shape of the columns, the number and type of turbines 14, and other factors would be adjusted to provide maximum efficiency.

Referring to FIG. 5, a hydrogen generator 30 may be used in the system 10. The hydrogen generator 30 may be used to produce hydrogen in one column 12 and oxygen in another column 12. As discussed above and shown in FIG. 1, each column 12 would have a plurality of turbines 14. The turbines 14 would convert the energy of the rising bubbles into mechanical energy to drive generators for producing electricity. The hydrogen and oxygen could then be recollected at the top of each column 12. The recollected gas could then be used to power a hydrogen powered turbine generator with a boiler to co-generate a steam turbine. The additional energy would give the system 10 greater efficiency. Alternatively, water electrolysis may be used for producing the hydrogen and oxygen gas bubbles. Water electrolysis is the passing of an electrical current through water to split individual water molecules into their constituent hydrogen and oxygen atoms. Alternatively, a hydrogen-oxygen-carbon gas mixture may be used and can be generated during electrolysis by using carbon rods as the electrodes.

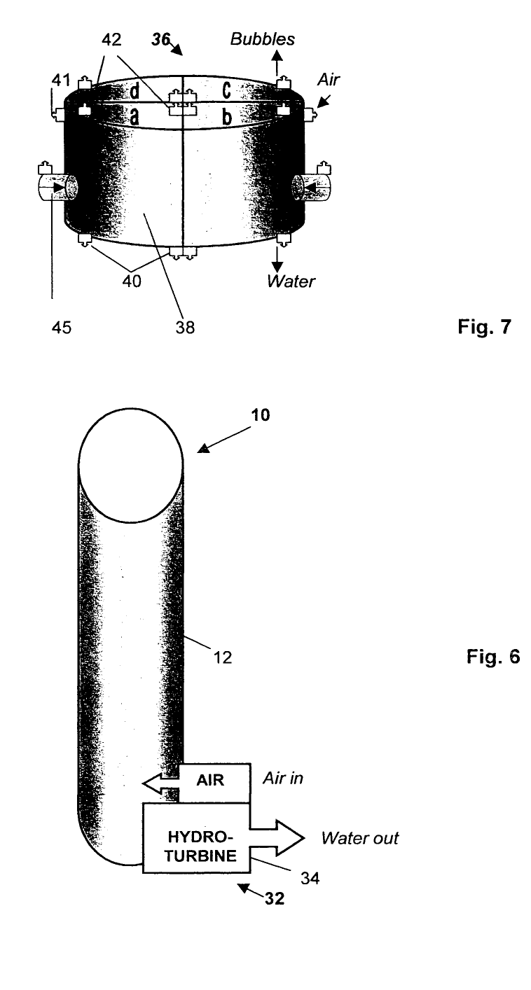

Referring to FIG. 6, the system 10 may be used to co-generate power with a hydroelectric system 32. In the case of co-generating power with a hydroelectric system 32, a hydro-turbine 34 will generate air as water runs through the hydro-turbine 34. The air generated can be pumped to the base of the column 12 where the air is released. The air bubbles would then rise through the column 12 turning the plurality of turbines 14 until the air bubbles reach the top of the column 12. The rotation of the turbines 14 is then used to power a generator for producing electricity.

Referring to FIG. 7, a mechanical system 36 is shown for generating the air/gas bubbles. The mechanical system 36 would be a series of chambers 38 which are located at the bottom of the column 12. Each chamber 38 would have a plurality of valves. In operation, each chamber would work accordingly. One or both of the valves 40 are opened to allow water in the chamber 38 to flow out as air enters the chamber 38 to create a hollow void. Valve 41 would open to allow the air to enter the chamber 38. Valves 42 are opened to allow air to escape and to enter the column 12 and water to refill the chamber 38 via valve 45. The multiple chambers 38 will release air in sequence one after another. Once air is released, each chamber 38 is re-energized, thus maintaining a constant bubble flow. The air bubbles will constantly rise through the column 12 turning a plurality of turbines 14 until the air bubbles reach the top of the column 12. The rotation of the turbines 14 is then used to power a generator for producing electricity. Where the liquid is drained into the base of the column 12 for chambers with valves, the liquid must not flow opposing the turbines 14. Thus requiring an interfacing piping system.

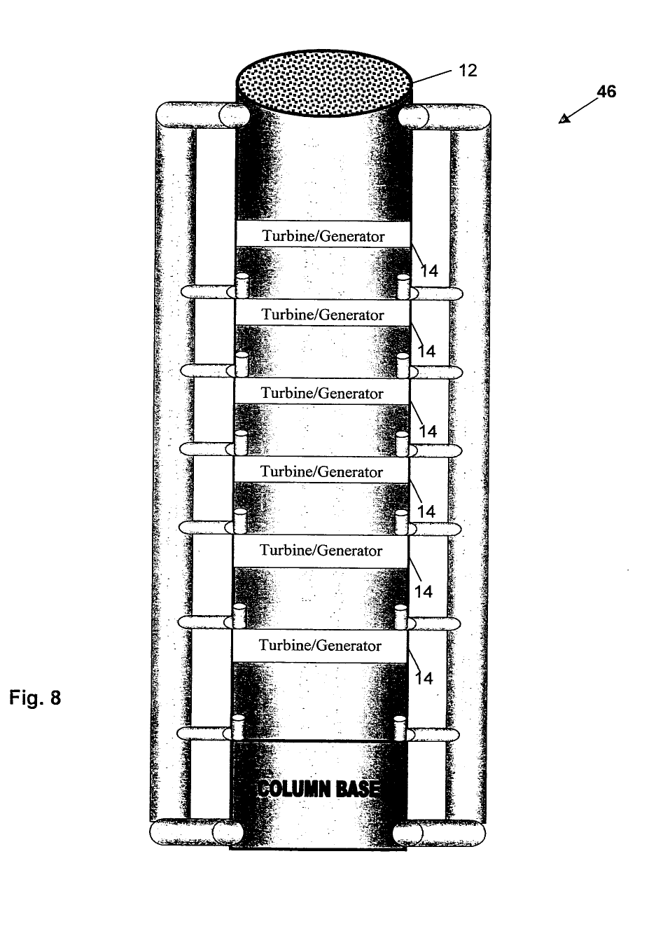

Referring to FIG. 8, an interfacing pipe system 46 will allow the same pressure in both the column 12 and the pipe system 46 to distribute the liquid without disruption of the bubble flow. The water pressure is constant when the column 12 and the piping system 46 are the same height. The top of the column 12 is open for the water supply and the release of air. The interfacing piping could also be used in the embodiment depicted in FIG. 5. Although, column 12 would be sealed at the top for removing the hydrogen, and water would be introduced into the column by the piping system 46.

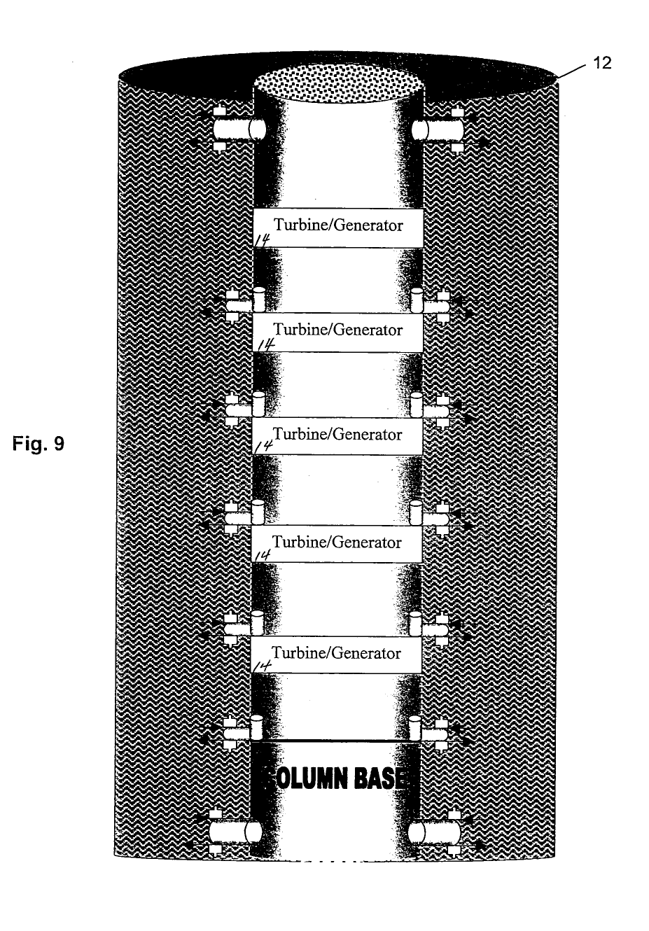

Interfacing could be done on a column 12 which is submerged in a tank or in a body of water. Pipes and valves would do the interfacing as shown in FIG. 9. The embodiment depicted in FIG. 9 would allow a liquid to reach equilibrium at all levels and depths to prevent pressure restrictions with the column 12.

While the invention has been particularly shown and described with reference to preferred embodiments thereof, it will be understood by those skilled in the art that the foregoing and other changes in form and details may be made therein without departing from the spirit and scope of the invention.

1. A system for capturing gas bubbles and converting the captured gas bubbles into electrical energy comprising:
an elongated tubular structure filled with a liquid and having an open top end wherein the tubular structure is positioned over a gas source, the gas source creating gas bubbles which will flow up the tubular structure and out the top end; and
at least one turbine coupled to an interior surface of the tubular structure wherein the turbine will capture the gas bubbles causing the turbines to rotate and produces electrical power.

2. A system for capturing gas bubbles and converting the captured gas bubbles into electrical energy in accordance with claim 1 further comprising a plurality of turbines.

3. A system for capturing gas bubbles and converting the captured gas bubbles into electrical energy in accordance with claim 1 wherein the turbine comprises:
an elongated pole running a length of the column;
a plurality of disks coupled to the elongated pole wherein the disks will capture the gas bubbles causing the disks to rotate, the rotation of the disks causing the elongated pole to rotate;
a plurality of magnets coupled to the elongate pole; and
wiring, the magnets rotating past the wiring to produce electricity.

4. A system for capturing gas bubbles and converting the captured gas bubbles into electrical energy in accordance with claim 1 wherein the turbine comprises:
a plurality of poles;
a disk coupled to each of the poles wherein the disk will capture the gas bubbles causing the disk to rotate, the rotation of the disk causing the pole to rotate;
a plurality of magnets coupled to each pole; and
wiring, the magnets rotating past the wiring to produce electricity.

5. A system for capturing gas bubbles and converting the captured gas bubbles into electrical energy in accordance with claim 1 wherein the turbine comprises:
an elongated pole running a length of the column wherein the pole is magnetized;
a plurality of disks coupled to the elongated pole wherein the disks will capture the gas bubbles causing the disks to rotate; and
wiring coupled to the disk, the rotation of the disk causing the wiring to rotate around the magnetized elongated pole to produce electricity.

6. A system for capturing gas bubbles and converting the captured gas bubbles into electrical energy in accordance with claim 1 wherein the turbine comprises:
a plurality of poles wherein each pole is magnetized;
a disk coupled to each pole wherein the disk will capture the gas bubbles causing the disk to rotate; and
wiring coupled to each disk, the rotation of the disk causing the wiring to rotate around the magnetized pole to produce electricity.

7. A system for capturing gas bubbles and converting the captured gas bubbles into electrical energy in accordance with claim 1 wherein the turbine comprises:
a lever; and
a flotation cup coupled to one end of the lever, the flotation cup capturing the bubbles causing the flotation cup to rise and lifting the lever, the lever returning to a starting position when the gas bubbles are removed, the up and down movement of the lever used to power a generator for producing electricity.

8. A system for capturing gas bubbles and converting the captured gas bubbles into electrical energy in accordance with claim 1 wherein the turbine comprises:
a wheel rotatably coupled to an interior surface of the column; and
a plurality of vanes coupled to the wheel, the vanes capturing the bubbles causing the wheel to rotate, the rotation of the wheel used to power a generator for producing electricity.

9. A system for capturing gas bubbles and converting the captured gas bubbles into electrical energy in accordance with claim 1 wherein the gas source is a naturally occurring gas source.

10. A system for capturing gas bubbles and converting the captured gas bubbles into electrical energy in accordance with claim 1 wherein the gas source is chemically created by mixing a chemical compound with the liquid in the tubular structure.

11. A system for capturing gas bubbles and converting the captured gas bubbles into electrical energy in accordance with claim 1 wherein the gas source is created by a hydrogen generator.

12. A system for capturing gas bubbles and converting the captured gas bubbles into electrical energy in accordance with claim 1 wherein the gas source is created by water electrolysis.

13. A system for capturing gas bubbles and converting the captured gas bubbles into electrical energy in accordance with claim 1 wherein the gas source is a hydro-turbine which generates air when water runs through the hydro-turbine.

14. A system for capturing gas bubbles and converting the captured gas bubbles into electrical energy in accordance with claim 1 wherein the gas source is a plurality of air chambers wherein each chamber has a plurality of valves, the plurality of valves used to allow water to enter and exit the air chamber and to allow air to enter and escape to generate the air bubbles.
